(19) United States
(12) Patent Application Publication
(10) Pub. No.: US 2011/0181998 A1
(43) Pub. Date: Jul. 28, 2011

(54) DEPOSITED FILM AND FILM CAPACITOR USING THE SAME

(75) Inventors: Chang-Hoon YANG, Cheonan-City (KR); Dae-Jin PARK, Cheonan-City (KR); Yong-Won JUN, Cheonan-City (KR)

(73) Assignee: NUINTEK CO., LTD., Asan-City (KR)

(21) Appl. No.: 12/723,723

(22) Filed: Mar. 15, 2010

(30) Foreign Application Priority Data
Jan. 27, 2010 (KR) 2010-0007479

(51) Int. Cl. H01G 2/16

(52) U.S. Cl. 361/275.4

(57) ABSTRACT

There is provided a deposited film for a film capacitor, which comprises: a thermally sprayed metal contact part formed at one end of a dielectric in a width direction of the dielectric, and a margin part having no deposited metal formed at the other end of the dielectric in the width direction of the dielectric; a split electrode in a rectangular shape formed by forming a T-shaped window margin, from the margin part to a predetermined position within a width range of the deposit film, in the width direction of the deposited film; and a fuse part formed between the split electrodes in the width direction of the deposited film, wherein adjacent fuse parts in the length direction of the deposited film are formed in a stepped layout in the width direction of the deposited film.

### CROSS-REFERENCE TO RELATED APPLICATION

This application claims the benefit of Korean Patent Application No. 2010-0007479, filed Jan. 27, 2010, the disclosure of which is hereby incorporated herein by reference in its entirety.

### BACKGROUND OF THE INVENTION

1. Field of the Invention

The present invention relates to a deposited film used for a film capacitor in a winding type or a stack type, and a film capacitor using the deposited film, and more particularly, to a deposited film used for a film capacitor and a film capacitor using the deposited film to improve temperature characteristics by preventing rising to a high temperature in the film capacitor and thus preventing a decrease of pressure resistance in the film capacitor, to improve the safety of the film capacitor at high temperatures and large currents and to prolong the life of use of the film capacitor by reducing a decrease in capacitance by the operation of a fuse part, and to be miniaturized by using a thin dielectric film.

2. Description of the Related Art

In general, film capacitors are widely used in many industrial fields. Examples of the capacitors include electric device capacitors, low-pressure phase advance capacitors, inverter capacitors and filter capacitors, among others.

These capacitors are manufactured, using a dielectric film (or called a plastic film) and a deposited film. The dielectric film uses polyethylene terephthalate (PET) resin, a polypropylene (PP) resin, a polyethylene naphthalate (PEN) resin, a polycarbonate (PC) resin, a polyphenylene sulfide (PPS) resin, or the like. As an electrode, the deposited film is prepared by depositing one side or both sides of the dielectric film with zinc, aluminum, an aluminum alloy, or both aluminum and zinc (first deposition with aluminum and second deposition with zinc).

A film capacitor is manufactured by winding a pair of two sheets of the deposited films. To use both sides of a capacitor device wound with the deposited films to form electrodes, the both sides of the capacitor device are coated with zinc or a zinc alloy by thermal spraying, so that a thermally sprayed surface is formed. A busbar, an electrode leading line, or an electrode terminal is connected onto the thermally sprayed surface by spot welding or soldering. Subsequently, the capacitor device is placed into an outer case. The outer case is filled with an insulator, such as epoxy or urethane, and is cured. Based on this method, a capacitor in a case mold form is manufactured.

A power source is connected to the busbar, electrode leading line or electrode terminal of the capacitor device. Then, currents flow from the thermally sprayed surface formed on a side of the capacitor device in a width direction of the deposited films. The amount of the currents flowing in the capacitor device is in proportion to the area of a deposited metal. A large amount of the currents flow in the deposited films being close to the thermally sprayed surface in the width direction of the deposited films, whereas a relatively less amount of the currents flow in the deposited films being far from the thermally sprayed surface.

FIGS. 2A, 2B, 2C and 2D illustrate a conventional deposited film 1. In the conventional deposited film 1 for a film capacitor, a metal 2 is deposited onto a dielectric film 10. The deposited metal 2 is formed without any split electrode. Therefore, there is no fuse part in the deposited metal 2. The deposited film 1 has a margin part 3 having no deposited metal 2 in a length direction of the deposited film 1. A thermally sprayed metal contact part 12 is formed at an end opposite to a margin part 3 having no deposited metal 2 in a length direction of the deposited film 1.

However, the film capacitor using the aforementioned film 1 has a temperature fuse or a current fuse, or it includes a separate safety device so that the safety of the film capacitor is secured and the film capacitor is used at high voltages and high temperatures. However, when the electrical pressure resistance occurs, the safety device installed inside the film capacitor operates to block the film capacitor from the power source and thus the film capacitor loses its function. Further, since the film capacitor using the aforementioned film 1 uses a thick deposited film of 1 μm to 3 μm, the size of the film capacitor is big and the costs are high.

FIGS. 3A, 3B, 3C and 3D illustrate a deposited film 1 to improve the aforementioned problems of the conventional deposited film 1 as shown in FIGS. 2A, 2B, 2C and 2D. In the deposited film 1 illustrated in FIGS. 3A to 3D, a release agent, such as oil or the like, is applied in a regular shape onto the surface of a dielectric film 10 in the deposition process of the deposited film 1, to form a window margin 5b. Subsequently, when depositing a metal, the metal is not deposited in the window margin 5b so that a deposited metal 2 is divided to form a plurality of split electrodes 4. Each split electrode 4 has a fuse part 6 which is connected to the deposited metal 2 of a narrow width.

Specifically, the conventional deposited film 1 as illustrated in FIGS. 3A through 3D consists of a pair of two sheets of the deposited films 1a and 1b. One sheet of the deposited film 1a is structured to have the split electrodes 4 formed on the whole surface of the deposited metal 2. The other sheet of the deposited film 1b is structured without any electrodes 4. A thermally sprayed metal contact part 12 is formed at an end opposite to a margin part 3 having no deposited metal 2 in a length direction of the deposit film 1. In the sheet of the deposited film 1a having the split electrodes 4, the split electrodes 4 are formed with the deposited metal 2 by the T-shaped window margins 5b, and the fuse parts 6 are positioned at the window margins 5a formed in the length direction of the deposited film 1. When a dielectric breakdown occurs within any of the split electrodes 4, the relevant fuse part 6 blocks the broke-down split electrode 4 from the power source, thereby decreasing the capacitance of the capacitor by only as much as the area of the blocked split electrode 4 and preventing the capacitor from further breaking down, so that the capacitor continues performing its function.

In general, the aforementioned film capacitor has the structure in which currents flow from the thermally sprayed metal contact part 12 of the deposited film 1 toward the margin part 3. As described above, a large amount of the currents flows at the deposited film 1 being close to the thermally sprayed surface or the thermally sprayed metal contact part 12, whereas a relatively less amount of the currents flows at the deposited film being far from the thermally sprayed surface or the thermally sprayed metal contact part 12. Therefore, in the structure in which the fuse parts 6 are positioned proximately to the thermally sprayed metal contact part 12, the heat which is generated by a bottleneck phenomenon of high-capacity currents flowing from the thermally sprayed surface or the thermally sprayed metal contact part 12 overlaps with the heat which is generated by the contact resistance between the metal used for thermal spraying and the thermally sprayed metal contact part 12. This rises the temperature of the film capacitor and decreases the insulation of the dielectric film 10. Consequently, when the film capacitor is used at high temperatures, the function of the fuse parts 6 is not safe.

### SUMMARY OF THE INVENTION

Therefore, it is an object of the present invention to solve the aforementioned problems of a conventional deposited film for a film capacitor.

In accordance with an aspect of the present invention to achieve the aforementioned object of the present invention, there is provided a deposited film for a film capacitor which includes a pair of first and second metal-deposited films, comprising: a thermally sprayed metal contact part formed at one end of a dielectric in a width direction of the dielectric, and a margin part having no deposited metal formed at the other end of the dielectric in the width direction of the dielectric; a T-shaped window margin formed, starting from the margin part to a predetermined position within the width of the deposited film and in the width direction of the deposited film, and a split electrode in a rectangular shape formed by the T-shaped window margins, wherein the split electrode has the opposite sides in the width direction of the deposited film which are longer than the opposite sides in a length direction of the deposited film; and a fuse part formed between the split electrodes in the width direction of the deposited film, wherein adjacent fuse parts in the length direction of the deposited film are formed in a stepped layout in the width direction of the deposited film.

Preferably, one or more split electrodes are formed in the width direction of the deposited films but the present invention does not specify the number of the split electrodes.

When the pair of the first and second deposited films overlap, among the window margins in the length direction of the deposited films, the second window margins from the end opposite to the margin part in the first deposited film overlap with the second window margins from the end opposite to the margin part in the second deposited film, so that the length of the overlapping is second window margins of the first and second deposited films is greater than the length of the window margin in the width direction of the deposited films.

When two or more split electrodes are formed in the width direction of the deposited films, another fuse part is further formed between the adjacent split electrodes being close to the margin part.

In accordance with another aspect of the present invention, there is provided a film capacitor using the above-described deposited film.

### BRIEF DESCRIPTION OF THE DRAWINGS

The above and other features and advantages of the present invention will become more apparent to those of ordinary skill in the art by describing in detail preferred embodiments thereof with reference to the attached drawings in which:

FIG. 1A illustrates a first deposited film, among a pair of two sheets of deposited films for a film capacitor according to the present invention;

FIG. 1B illustrates a second deposited film, among the pair of the deposited films shown in FIG. 1A;

FIG. 1C illustrates the overlapping of the first and second deposited films shown in FIGS. 1A and 1B;

FIG. 1D is a top view illustrating the deposited films of FIG. 1C;

FIG. 2A illustrates one sheet of a deposited film, among a pair of two sheets of deposited films for a film capacitor according to the conventional art;

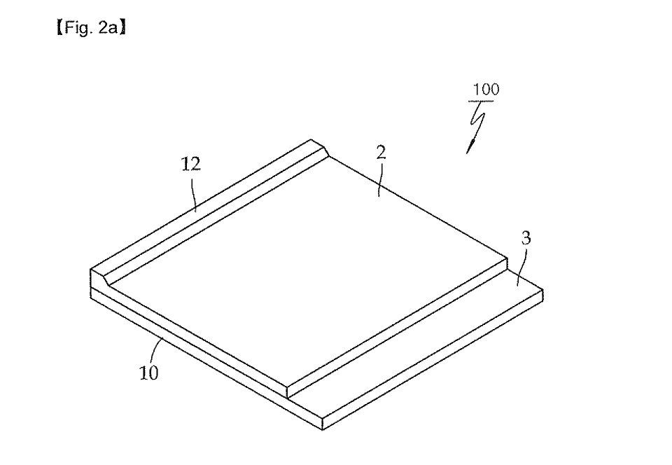

FIG. 2B illustrates the other sheet of the deposited film, among the pair of the deposited films shown in FIG. 2A;

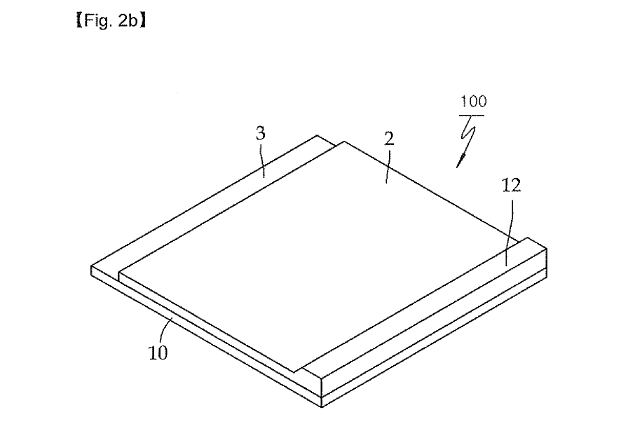

FIG. 2C illustrates the overlapping of the two sheets of the deposited films shown in FIGS. 2A and 2B;

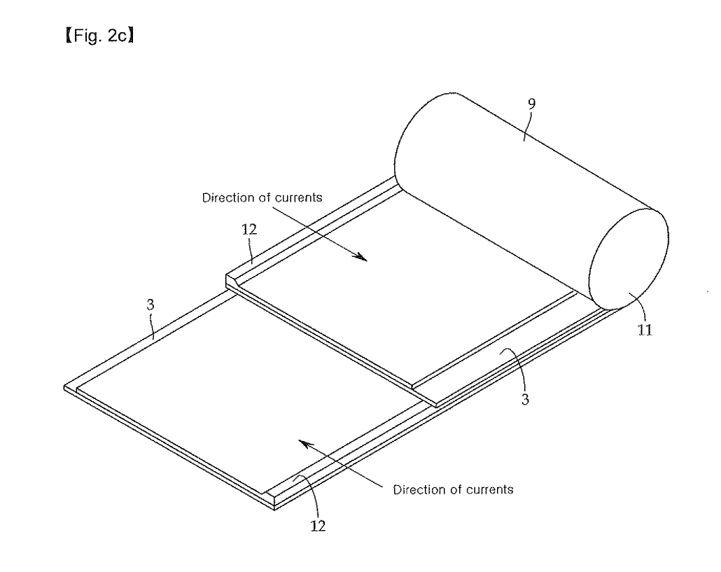

FIG. 2D is a top view illustrating the deposited films of FIG. 2C;

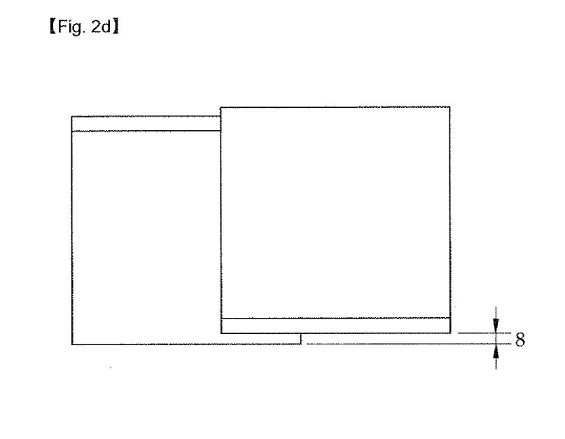

FIG. 3A illustrates one sheet of a deposited film having no split electrode, among a pair of two sheets of deposited films for a film capacitor according to the other conventional art;

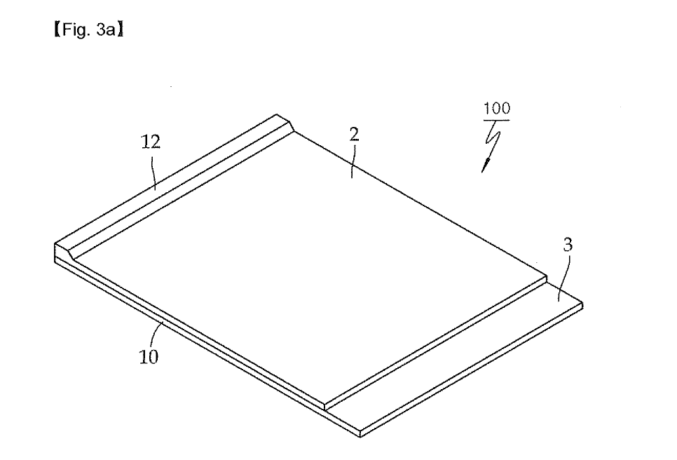

FIG. 3B illustrates the other sheet of the deposited film having a split electrode, among the pair of the deposited films shown in FIG. 3A;

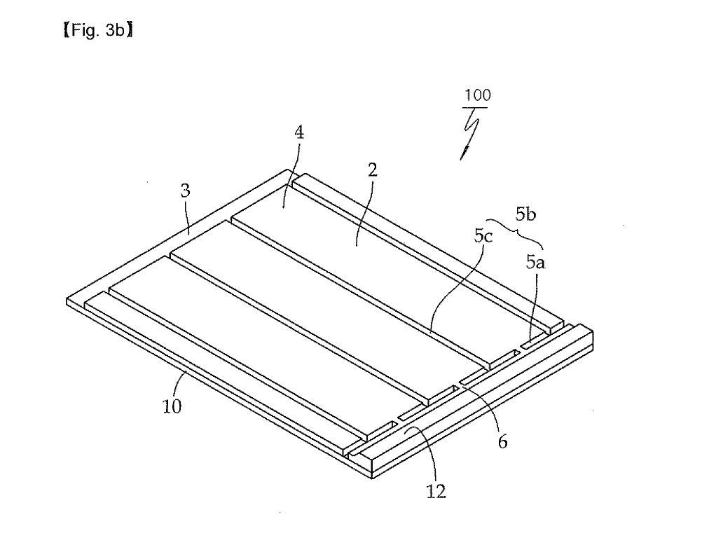

FIG. 3C illustrates the overlapping of the two sheets of the deposited films shown in FIGS. 3A and 3B; and

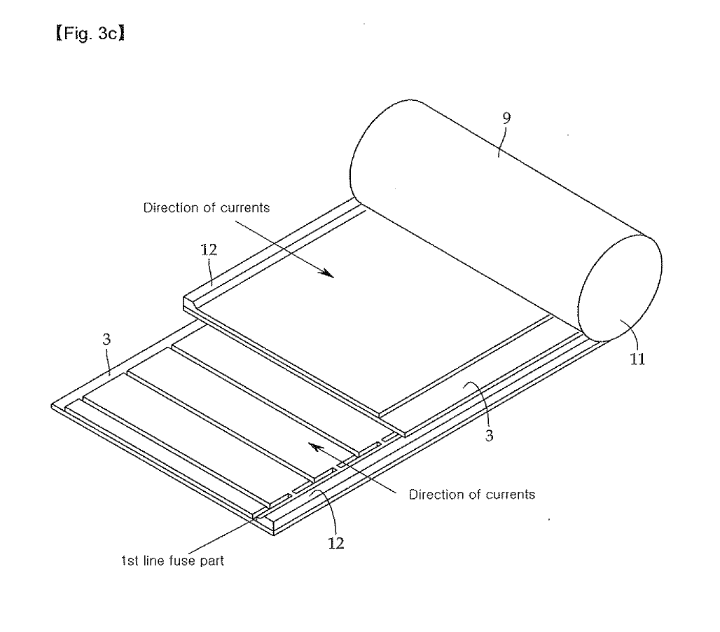

FIG. 3D is a top view illustrating the deposited films of HG. 3C.

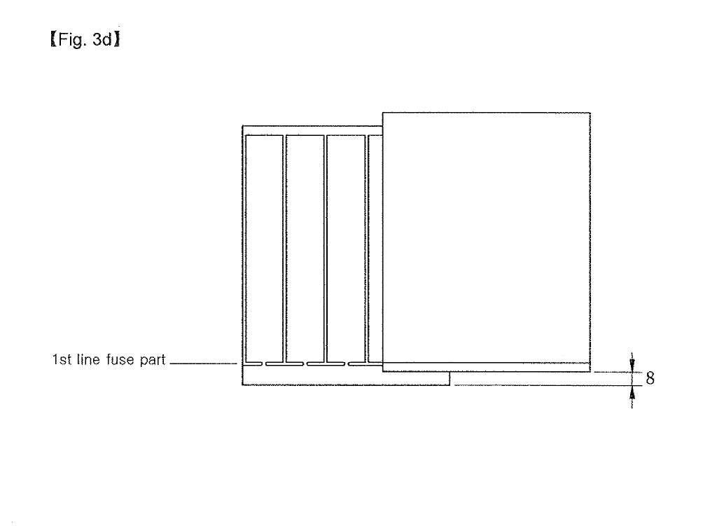

### DETAILED DESCRIPTION OF THE PREFERRED EMBODIMENT

The present invention will now be described more fully hereinafter with reference to the accompanying drawings, in which preferred embodiments of the invention are shown, so that those of ordinary skill in the art can easily carry out the technical idea of the present invention.

It will be further understood that, although the terms, “first”, “second”, etc., may be used herein to describe various elements, these elements should not be limited by these terms. These terms are only used to distinguish one element from another, not to indicate relative importance or purposes. As used herein, the singular forms “a” “an” and “the” are intended to include the plural forms as well, unless the context clearly indicates otherwise.

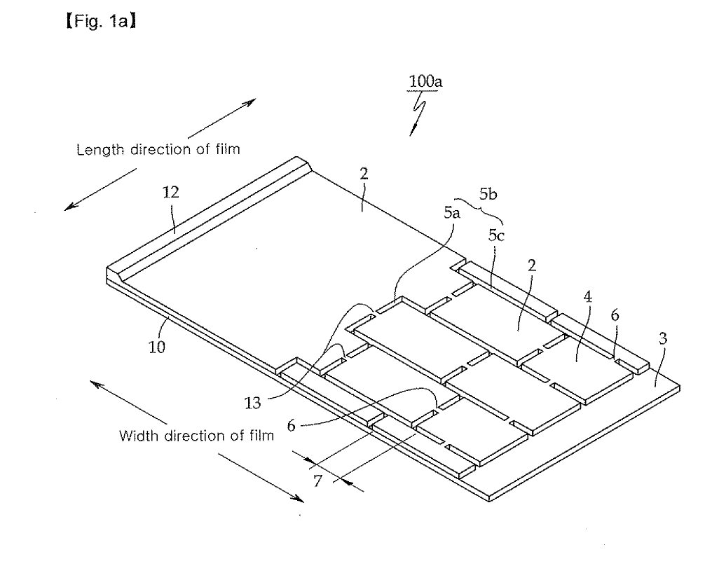

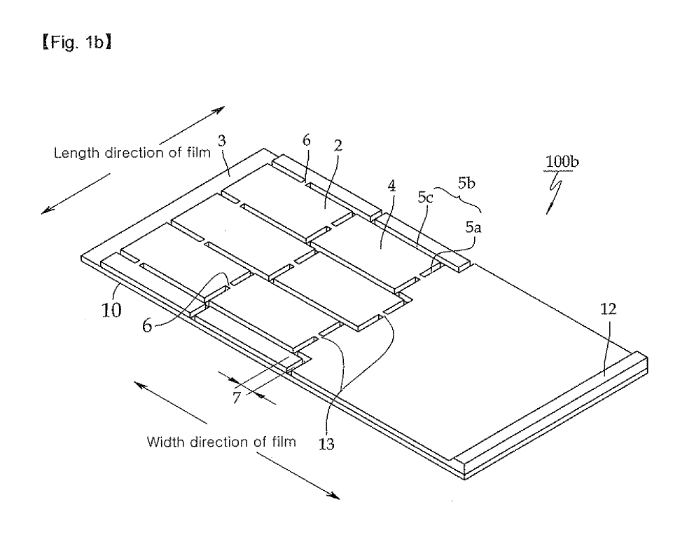

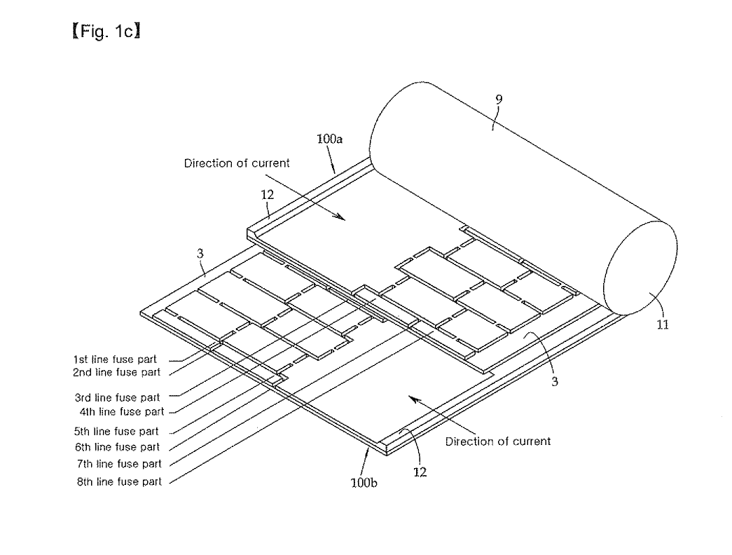

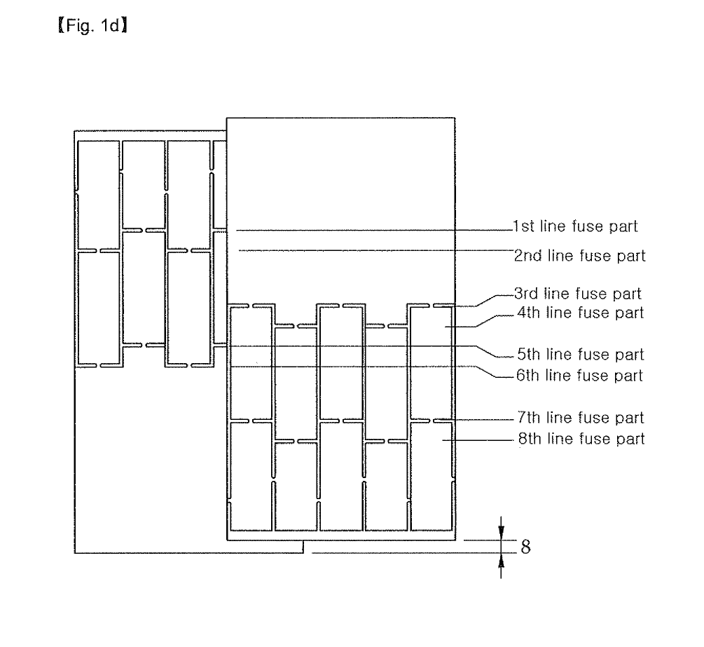

The present invention will be described with reference to FIGS. 1A, 1B, is 1C and 1D.

FIGS. 1A, 1B, 1C and 1D illustrate a deposited film 100 for a film capacitor 9 according to an embodiment of the present invention. As described above, the film capacitor 9 consists of a pair of two sheets of deposited films. FIG. 1A illustrates a first deposited film 100a among the two sheets of the deposited films, and FIG. 1B illustrates a second deposited film 100b among the two sheets of the deposited films.

As illustrated in FIGS. 1A and 1B, split electrodes 4 are formed on both of the deposited films 100a and 100b used for the film capacitor 9. A metal 2 deposited onto the deposited films 100a and 100b forms the split electrodes 4 with T-shaped window margins 5b. The window margins 5b are formed, extending from a margin part 3 toward a thermally sprayed metal contact part 12, namely, at a predetermined position in a width direction of the deposited film 100. Each split electrode 4 is in a rectangular shape with the opposite sides in the width direction of the deposited film 100 being longer than the opposite sides in a length direction of the deposited film 100.

At least one or more split electrodes 4 are formed in the width direction of the deposited film 100. When two or more split electrodes 4 are formed in the width direction of the deposited film 100, the adjacent split electrodes 4 being close to the margin part 3 are connected to each other by a fuse part 6. Window margins 5a of the adjacent split electrodes 4 in the length direction of the deposited film 100 are formed in a stepped layout 7 in the width direction of the deposited film 100.

Further, at least one or more fuse parts 6 are formed at the window is margin 5a in the length direction of the deposited film 100. The thermally sprayed metal contact part 12 is formed in the length direction of the deposited film 100 at the end opposite to the margin part 3 having no deposited metal 2.

As illustrated in FIGS. 1A and 1B, the capacitor 9 is manufactured by winding the first and second deposited films 100a and 100b including the split electrodes 4 in the manner that the split electrodes 4 formed on the first deposited films 100a are positioned obliquely to the split electrodes 4 formed on the second deposited films 100b, along the width direction of the deposited film 100.

FIGS. 1C and 1D schematically illustrate the pair of the first and second deposited films 100a and 100b for the film capacitor 9 of FIGS. 1A and 1B, which are wound such that the split electrodes 4 of the first deposited film 100a are positioned obliquely to the split electrodes 4 of the second deposited films 100b, along the width direction of the deposited film 100.

As illustrated in FIGS. 1C and 1D, in the aforementioned structure according to the present invention, first fuse parts 13 having high heat generation by the large currents of the thermally sprayed metal contact part 12 and the bottleneck phenomenon of currents are spaced apart from the thermally sprayed metal contact part 12, so that the heat generation of the first fuse parts 13 is prevented from overlapping with the heat generation by the contact resistance between the metal used for thermal spraying and the thermally sprayed metal contact part 12.

As illustrated in FIGS. 1C and 1D, when the pair of the first and second deposited films 100a and 100b overlap, among the window margins 5a in the length direction of the first and second deposited films 100a and 100b, the second window margins 5a from the end opposite to the margin part 3 in the first deposited film 100a (i.e., the second window margin 5a where the fourth line fuse parts) overlap with the second window margins 5a from the end opposite to the margin part 3 in the second deposited film 100b (i.e., the second window margin 5a where the fifth line fuse parts), so that the length of the overlapping second window margins 5a of the first and second deposited films 100a and 100b is greater than the length of the window margin 5c in the width direction of the first and second deposited films 100a and 100b. This secures the safety by the fuse parts 6. Even if the fuse parts 6 of the last split electrodes 4 from the margin part 3 toward the end opposite to the margin part 3 in the width direction of the deposited films 100a and 100b operate to block the split electrodes 4 being close to the margin part 3 from the power source, the power source is applied through the side split electrodes 4 in the length direction of the deposited films 100a and 100b. Therefore, a decrease in capacitance is minimized.

Further, the fuse parts 6 of the first and second deposited films 100a and 100b do not overlap in the center part of the capacitor 9 and these are positioned in the stepped layout 7. Therefore, the generated heat is evenly distributed to first, second, third, fourth, fifth, sixth, seventh and eighth line fuse parts, so that heat at a high temperature is prevented from generating at any portion of the capacitor 9. The heat generation is distributed throughout the whole capacitor 9, and the insulation of a dielectric film 10 is prevented from decreasing. Consequently, the safety of the capacitor 9 is secured at high temperatures and large currents, and the life of use of the capacitor 9 is prolonged.

The width of the fuse part 6 is preferably 0.01 mm to 5 mm. The fuse parts 6 of the adjacent split electrodes 4 are preferably formed at a position spaced apart from each other, at about 1 mm to 40 mm, in the width direction of the deposited film 100.

The thermally sprayed metal contact part 12 is formed at the end opposing to the margin part 3 in the width direction of the deposited film 100. The resistance of the deposited metal in the thermally sprayed metal contact part 12, is preferably 0.5 Ω/cm² to 10 Ω/cm², and the resistance of the deposited metal in the other portions is preferably 2 Ω/cm² to 30 Ω/cm².

Further, it is preferable to form a uniform structure in which the resistance of the deposited metal for the electrodes is 0.5 Ω/cm² to 30 Ω/cm².

In the above detailed description and the drawings attached to the application for the present invention, one fuse part 6 is formed in the window margin 5a or 5c of the split electrode 4. However, the number of the fuse parts 6 may be variously added/subtracted at a manufacturer's intention. The split electrodes 4 may be formed at various positions within the width range of the deposited film, extending from the margin part 3 toward the end opposing to the margin part 3 in the width direction of the deposited film. The number of the split electrodes 4 in the width direction of the deposited film may be variously selected, depending on the width of the deposited film.

Further, when the split electrodes of any one of the pair of the first and second deposited films are progressively smaller in size or the number of the split electrodes 4 progressively decreases from the margin part 3 toward the end opposing to the margin part 3 in the width direction of the deposited film, the split electrodes 4 of the other deposited film are formed so as to be progressively bigger or to progressively increase in number, so that when the pair of the first and second deposited films overlap, among the window margins 5a in the length direction of the deposited films, the second window margins 5a from the end opposite to the margin part 3 in the first deposited film overlap with the second window margins 5a from the end opposite to the margin part 3 in the second deposited film, so that the length of the overlapping second window margins 5a of the first and second deposited films is greater than the length of the window margin 5c in the width direction of the first and second deposited films.

In accordance with the present invention, the first fuse parts 13 where large currents flow and the greatest heat generation is made by the bottleneck phenomenon of the currents are spaced apart from the thermally sprayed metal contact part 12, thereby preventing the overlapping of the heat generation in the first fuse parts 13 and the heat generation by the contact part of the thermally sprayed surface and the metal used for thermal spraying and therefore, preventing the rising of temperature of the capacitor.

Furthermore, when winding the pair of two sheets of the deposited films, the fuse parts of the deposited films do not overlap in the middle of the capacitor and the fuse parts are positioned in the stepped layout, thereby preventing the temperature of the capacitor from being high at any portion and preventing the rising at a high temperature of the capacitor by distributing the heat generation to the whole capacitor. Consequently, the insulation of the dielectric film is prevented from decreasing, thereby improving the temperature characteristics of the capacitor. Furthermore, the safety of the capacitor is secured at high temperatures and large currents, the life of use of the capacitor is prolonged, and the use of a thin dielectric film is favorable to the miniaturization of the capacitor.

The invention has been described using preferred exemplary embodiments. However, it is to be understood that the scope of the invention is not limited to the disclosed embodiments. On the contrary, the scope of the invention is intended to include various modifications and alternative arrangements within the capabilities of persons skilled in the art using presently known or future technologies and equivalents. The scope of the claims, therefore, should be accorded the broadest interpretation so as to encompass all such modifications and similar arrangements.

### BRIEF DESCRIPTION OF REFERENCE NUMBERS OF MAJOR ELEMENTS

| | | | |
|---|---|---|---|
| 100: | deposited film | 2: | metal |
| 3: | margin part | 4: | split electrode |
| 5b: | window margin | 6: | fuse part |
| 7: | difference | 10: | dielectric |
| 13: | first fuse part | | |

What is claimed is:

1. A deposited film for a film capacitor which includes a pair of first and second metal-deposited films, comprising:
a thermally sprayed metal contact part formed at one end of a dielectric in a width direction of the dielectric, and a margin part having no deposited metal formed at the other end of the dielectric in the width direction of the dielectric;
a split electrode in a rectangular shape formed by forming a T-shaped window margin, from the margin part to a predetermined position within a width range of the deposit film, in the width direction of the deposited film; and
a fuse part formed between the split electrodes in the width direction of the deposited film, wherein adjacent fuse parts in the length direction of the deposited film are formed in a stepped layout in the width direction of the deposited film.

2. The deposited film according to claim 1, wherein the number of the split electrodes in the width direction of the deposited film is one or more.

3. The deposited film according to claim 1, wherein, when the pair of the first and second deposited films overlap, among the window margins in the length direction of the deposited films, the second window margins counted from the end opposite to the margin part in the first deposited film overlap with the second window margins counted from the end opposite to the margin part in the second deposited film, so that the length of the overlapping second window margins is greater than the length of the window margin in the width direction of the deposited films.

4. The deposited film according to claim 1, wherein, when the number of the split electrodes is two or more in the width direction of the deposited films, fuse part is further formed between the adjacent split electrodes being closed to the margin part.

5. The deposited film according to claim 1, wherein the fuse part is further formed between the adjacent split electrodes in the length direction of the deposited films.

6. A film capacitor using a pair of first and second metal-deposited films, comprising:
a thermally sprayed metal contact part formed at one end of a dielectric in a width direction of the dielectric, and a margin part having no deposited metal formed at the other end of the dielectric in the width direction of the dielectric;
a split electrode in a rectangular shape formed by forming a T-shaped window margin, from the margin part to a predetermined position within a width range of the deposit film, in the width direction of the deposited film; and
a fuse part formed between the split electrodes in the width direction of the deposited film, wherein adjacent fuse parts in the length direction of the deposited film are formed in a stepped layout in the width direction of the deposited film.

7. The film capacitor according to claim 6, wherein the number of the split electrodes is one or more in the width direction of the deposited films.

8. The film capacitor according to claim 6, wherein, when the pair of the first and second deposited films overlap, among the window margins in the length direction of the deposited films, the second window margins counted from the end opposite to the margin part in the first deposited film overlap with the second window margins counted from the end opposite to the margin part in the second deposited film, so that the length of the overlapping second window margins is greater than the length of the window margin in the width direction of the deposited films.

9. The film capacitor according to claim 6, wherein, when the number of the split electrodes is two or more in the width direction of the deposited films, another fuse part is further formed between the adjacent split electrodes being closed to the margin part.

10. The film capacitor according to claim 6, wherein the fuse part is further formed between the adjacent split electrodes in the length direction of the deposited films.
